(19) United States
(12) Patent Application Publication
(10) Pub. No.: US 2025/0214365 A1
(43) Pub. Date: Jul. 3, 2025

(54) PROCEDURE AND MACHINE FOR DIGITAL DECORATION OF A SUBSTRATE

(71) Applicant: Jesús Francisco BARBERAN LATORRE, CASTELLDEFELS (BARCELONA) (ES)

(72) Inventor: Jesús Francisco BARBERAN LATORRE, CASTELLDEFELS (BARCELONA) (ES)

(21) Appl. No.: 18/852,090

(22) PCT Filed: Mar. 7, 2023
(86) PCT No.: PCT/ES2023/070122

§ 371 Date: Sep. 27, 2024

(30) Foreign Application Priority Data
Apr. 21, 2022 (EP) EP22382375.8

(51) Int. Cl. B44C 3/02; B08B 5/04; B41J 3/44; B41J 11/00; B41M 3/00; B41M 5/00

(52) U.S. Cl. CPC B44C 3/025; B08B 5/04; B41J 3/44; B41J 11/002; B41M 3/008; B41M 5/0011; B41M 5/0047

(57) ABSTRACT

A procedure for digital decoration of a substrate, comprising the application of a property modification pattern, such that, in the areas where the property modification pattern is applied, the physical properties of an ink used for printing the pattern are modified, the physical properties of the substrate or of a possible decorative motif printed on the substrate thereby varying in the areas. This variation depends on the physical properties, the number and the arrangement of microparticles applied to and fixed in the ink. A machine for digital decoration of a substrate wherein the aforementioned procedure is performed is also described.

### OBJECT OF THE INVENTION

The object of the present invention falls within the field of digital decoration of substrates. More specifically, a procedure and a machine for digital decoration of a substrate are described comprising the positioning of solid powder microparticles on and/or inside at least one ink. The microparticles are selected based on certain properties that provide different physical features to the ink and, therefore, to the decoration applied to the substrate.

### TECHNICAL PROBLEM TO BE SOLVED AND BACKGROUND OF THE INVENTION

From the state of the art, procedures for digital printing of substrates are known that enable said substrates to have different decorations. Procedures of this type can be used, for example, to apply decorations on substrates made of different materials, such as wood or wood-derived materials, plastic, metal, cement, cork, composite materials, etc. that can be subsequently used, for example for manufacturing construction materials such as floors, ceiling or wall panels, for manufacturing furniture, for manufacturing household appliances, etc.

A current problem is that, when printing on a certain substrate with currently known machines and procedures, a specific decoration is simply applied on a surface. When different properties are desired in a specific area of the substrate, which requires, for example, greater resistance to wear, the only solution currently applied in the sector would be to arrange a protective layer on said critical area.

Thus, there are no automated procedures that enable the physical properties of printed substrates to be changed quickly, automatically and effectively.

From the state of the art, methods for digital printing are known, for example, wherein a liquid binder is applied and subsequently dyes are applied which, in order to remain fixed on the printed surface, are subjected to heat and pressure.

Methods of surface modification are also known, comprising the arrangement of a liquid base on the surface and the modification of the thickness of said liquid base. When the desired thickness modifications have been made, the liquid base finally obtained is fixed.

### DESCRIPTION OF THE INVENTION

The invention relates to a procedure for digital decoration of a substrate and to a machine for carrying out said procedure.

The key to the proposed procedure is that it enables the physical properties of an ink to be modified such that the visible physical properties of a decorative image are modified, in specific points (or areas), thus obtaining different optical effects, or images that provide the substrate with an improved mechanical resistance, or conductivity, designs that provide the substrate with a releasable scent, etc. This entails an improvement with respect to the effects that can be obtained only by means of a decoration by means of conventional ink printing.

To carry out the procedure for digital decoration of the substrate, said substrate must have a surface suitable for receiving a liquid ink, either due to the very material of the substrate surface or because a pretreatment of said surface has been performed. In an exemplary embodiment of the invention, the procedure is carried out on a substrate comprising a decorative motif. In other exemplary embodiments, said decorative motif is printed before performing the steps related to modifying the properties or is printed after performing the steps related to modifying the properties. Decorative printing can be applied by means of inkjet (injection printing) or by other means.

In a possible exemplary embodiment, the procedure comprises an initial step of applying previous layers to prepare the surface in the area to be printed. This enables the inks to be injected to have, among other things, good adhesion to the surface. In this way, the correct adhesion of the ink to the substrate is guaranteed and the spreading or expansion of the injected drops is controlled, during the time that passes from the injection until it is fixed (using curing/drying).

Treatments of this type may include applying one or several layers of material or performing some surface treatment to prepare the substrates. Said substrates can be, for example, wooden panels, steel sheets, etc. Some of said layers are selected from a bottom layer, a levelling layer, a filler or pore-covering layer, a primer layer, a layer to be textured, etc. As described, there are cases where the substrate material is already suitable to receive printing and/or no pre-treatment or application of any of these layers is required. If the substrate material is not properly treated and/or is not made of a material suitable for printing, the print quality will be inadequate, for example due to ink droplets moving to adjacent pixels, excessive ink absorption, etc.) This may lead to, for example, overlapping of different coloured inks in areas where they do not correspond or which visually blur the printed digital image, or result in an image with degraded or dull colours.

Thus, the procedure for digital decoration is applied on a substrate comprising a surface to be worked on and that is suitable or has been prepared for applying said procedure. The decorative motif is arranged on said surface by digital application of at least one liquid ink and the application of at least one modification ink according to a property modification pattern, synchronised with the decorative motif. The property modification pattern determines a plurality of points wherein microparticles are to be fixed (on the modification ink in a gelled/semi-dry state, wherein the modification ink can be pigmented or transparent). The dosed microparticles enable the physical properties of the digital motif obtained to be modified, at the points wherein said microparticles are fixed. The most relevant parameters of the microparticles for performing the modification of the properties are: the physical properties of the material of the microparticles, the size of said microparticles, the number of applied microparticles and the arrangement of said applied microparticles.

Therefore, the result is a modification of the properties of the fixing ink of the microparticles, coordinated with respect to the printed decorative motif.

The microparticles are dosed on the entire surface or only on a portion thereof and adhere only to the areas where the modification ink is gelled/semi-dry. The decorative motif and the property modification pattern must be applied synchronously to ensure coordination and, therefore, a correct quality and resolution of the motif finally obtained (decorative motif with modified properties in at least a portion of said decorative motif).

The material of the microparticles to be applied is selected based on the physical properties that are to be achieved. For example, the reflective properties of the ink can be modified, the resistance properties thereof can be modified, the conductivity thereof can be modified, the flexibility thereof can be modified, or combinations thereof and/or others, etc., can be modified.

In this sense, the light-reflecting properties of the ink can be modified, for example, by modifying the degree of gloss, the colour, the degree of transparency, etc. Examples of microparticles that could be used would be particles of glitter, metallic powder, mother-of-pearl powder, sublimates, etc. A specific example of a material used as mother-of-pearl powder is mica coated with titanium oxide.

Microparticles can also be used to modify certain functional features of the ink, such as electrical conductivity, magnetic properties, flexibility, scent, etc. Another possible exemplary embodiment would be to modify the wear resistance properties, for example by applying microparticles of aluminium oxide powder (corundum).

Thus, the proposed procedure enables the physical features of a printing to be improved. Broadly speaking, the procedure comprises performing a digital printing by means of inkjet application of ink, varnish or lacquer, which can be UV-curable or water-based or solvent-based, on a substrate prepared therefor (on which one or more preparation treatments have been applied, for example a base layer for receiving the colour, a layer for performing textures, etc.), pigmented, unpigmented or a combination of both cases, with a decorative motif determined by a digital file comprising certain areas wherein at least one physical property of at least one ink is to be modified and wherein said printed ink acts as an adhesive for at least a portion of the microparticles to be dosed. It also comprises gelling/semi-drying the at least one ink using UV radiation, IR radiation, hot air, etc. on all the applied ink or only on a specific area thereof (selective drying/curing) and a dosing of microparticles, such that said microparticles remain adhered to the areas of interest wherein the gelled/semi-dry ink is present and removing the excess microparticles, for example by means of vacuuming, subsequently performing complete curing or drying using UV radiation, IR radiation, hot air, etc. It also preferably includes brushing/cleaning by mechanical means to remove any remaining microparticles that may have remained on the surface.

Throughout the specification, to simplify the description, the term “ink” is used to refer to both ink, varnish and/or lacquer. Furthermore, as previously described, the ink, varnish or lacquer can be UV-curable, water-based or solvent-based.

By controlling the viscosity of the modification ink (i.e., the degree of gelling and/or drying applied) the dispersion or degree of penetration of the powder microparticles dosed therein is controlled.

In the case of the present invention, the inks are applied digitally (by means of application procedures that do not require the application of powder) and in a manner synchronised between each other and the previously or subsequently applied inks, depending on the decorative motif that is going to be formed on the substrate, and also in a manner synchronised with the modification pattern. One of the differences compared to standard digital printing is that digital printing cannot be used for applying and fixing the microparticles. In other words, to obtain the desired result, single pass standard printing can be performed in the areas of the digital motif to be printed directly with the ink corresponding to said digital decorative motif, but for the areas wherein the properties are to be modified by applying microparticles on a modification ink, said microparticles have a non-injectable size and therefore they cannot be printed with the same heads as the inks.

Moreover, the procedure may comprise vacuuming the excess microparticles. To do this, the machine wherein the procedure is carried out may comprise vacuuming means for vacuuming the excess microparticles or to vacuum the particles removed by means of additional mechanical means. These vacuuming means are connected to a cyclone for the recovery and reuse of said excess particles.

Depending on the desired properties for the substrate or for specific areas thereof, one or more layers of final treatment of lacquers or varnishes (protective layers, or layers for modifying the degree of gloss, etc.) can be applied, for example with a roller or succession of rollers, by means of spraying, by means of varnish curtain, by means of inkjet, etc. with the corresponding drying or curing thereof, depending on the desired properties.

In the procedure, it is possible to perform the gelling or semi-drying on all the modification ink applied or selectively, just after the application thereof. Thus, in certain areas, the applied modification ink is dried or cured completely and in others it is not. This makes it possible to select areas within the ink itself wherein the microparticles adhere and others wherein they do not. Additionally, it is possible to apply different types of microparticles in a given ink, repeating the step of dosing microparticles in the gelled/semi-dry ink as many times as required.

Preferably, the microparticles that are applied in the gelled/semi-dry modification ink have a size of less than 20 μm. This is due to the fact that the digital printing of the “binder” (i.e., the ink that is going to be gelled/semi-dried, namely, the ink with properties that are to be modified) places, on the substrate to be decorated using printing, a plurality of drops in a plurality of positions determined by the digital printing itself. Some injectors project ink droplets onto the substrate depending on the digital decorative motif to be printed, controlled by a control unit in which the synchronisation of the digital motif to be printed and the modification pattern (which determines the points of the digital motif wherein the physical properties of the ink are to be modified by means of dosing and fixing of the microparticles) is carried out. The injectors (through which the ink droplets are emitted) are separated from each other by a distance of the order of micrometres (depending on the specific resolution of the injector head and/or the printer).

In single pass type printing, the heads with the different decorative inks for printing the digital motif are arranged occupying a maximum width to be printed. The substrate moves under said heads such that, as it passes, the injector heads project the ink drops at the right time, commanded by the control unit based on the decorative motif to be printed.

The drops injected onto the substrate are arranged on said substrate (forming “pixels”) at a distance characterised by the separation between injector nozzles, forming a master layout that is determined using calculation algorithms according to a computer software. At a macroscopic level, this arrangement of ink drops forms an appreciable design as a decorative motif (image and/or decorative texture, i.e., it is an image with texture, just an image, or just a texture).

As explained above, the distance between drops is of the order of micrometres, so if the microparticles were too large, the case could occur where said particles would occupy a space larger than the distance between pixels and interfere with each other. In this case, if another ink is injected after fixing the microparticles, there is a risk of injecting the ink on the particles fixed in the previously injected adjacent ink. Thus, if upon having dosed the microparticles, they have a size larger than that corresponding to a “pixel”, i.e., they are larger than the separation between nozzles of the injector, they will possibly invade positions that should be occupied by another colour and definition will be lost in the motif finally obtained.

The smaller the size of the particles, the greater the precision in the final decoration. However, there is also a lower limit for the particle size that depends on the type of physical property of the ink that is to be modified with the corresponding microparticles. In other words, a minimum size of the microparticles is required to continue ensuring that the ink is given a certain property that is to be given to the final motif. For example, when corundum particles are used, the minimum particle size should be 10 μm.

In addition, the dosing of the microparticles is more complex the smaller the size thereof, since they are more easily dispersed in the air. This problem could be solved by dispersing the microparticles in a carrier liquid that would enable these microparticles to be injected by means of injection heads, and converting the application thereof into a standard application process by means of ink injection, but also here the minimum size limitation must be taken into account to maintain the physical properties of the microparticles which are to be given to the applied ink.

A specific example could be the application, according to the procedure, of sublimable microparticles. This enables the surface on which they are fixed to be matted, by means of a subsequent treatment where the energy required for sublimation is provided. Said sublimation causes a micro-structuring of the ink on which the sublimating particles have been fixed, which produces the matting effect, i.e., it causes a change in the light reflection properties of the ink on which the microparticles have been deposited.

Another relevant factor is the grammage, i.e., the number of microparticles that are applied per surface unit. In certain cases, especially when the reflective properties of the ink are to be modified, a predetermined threshold of the number of microparticles applied on a given ink area must not be exceeded. In this way, the original optical properties of the ink are prevented from being cancelled. In one possible example, to create pearlescent effects on certain areas of a digital image, mother-of-pearl microparticles with a grammage of between 2 and 4 gr/m² are applied. This achieves a pearlescent effect of the colours in the areas of interest without concealing the applied colours themselves.

The procedure of the present invention is a very versatile procedure since it enables printing to be adapted to the specific requirements of each substrate and/or each decorative motif to be printed.

For example, in cases where only the physical properties of the ink of a certain colour are to be modified, the rest of the decorative inks can be injected and completely dried for applying the pigmented modification ink before or after and then, only therein, performing the gelling and dosing of the microparticles. Subsequently, the rest of the steps are performed normally (for example: removal of excess microparticles, complete curing of the ink itself, cleaning of remains, for example using brushing, application of a protective varnish, etc.).

If, before printing the modification ink, a decorative motif made up of several inks, pigmented or not, is going to be printed, gelling or semi-drying can be performed between the injection of each different ink, i.e., fully curing/drying each one of these inks is not required. In fact, this would be the preferred embodiment provided that after applying the last ink, and before printing with the modification pattern ink, all previously injected pigmented inks are fully cured/dried.

If after applying the microparticles on the modification ink, in a gel or semi-dry state, and after vacuuming the excess microparticles, another decorative motif is to be printed or printed with some other ink, provided that there is no need for subsequent mechanical brushing that could remove the semi-cured or semi-dry modification ink already with the microparticles therein, the step of fully curing/drying said modification ink with the microparticles could be eliminated, so that the surface receives the following ink with the modification ink in this condition. This embodiment can ensure better adhesion of the inks to each other.

However, in cases wherein physical properties are to be modified on inks of various colours, it may be more convenient to perform complete digital printing of the decorative motif and a corresponding complete drying/curing. Subsequently or previously, a transparent modification ink is applied in the specific areas wherein the physical properties are to be modified and, on said areas, the dosing of the microparticles is performed. More specifically, the dosing of the microparticles is carried out on the entire surface of the substrate (or at least in large areas compared to the areas where they are actually to be fixed) and only those that fall on the modification ink that is gelled or semi-dry are retained on the substrate.

Likewise, it could be the case that some physical property is to be modified on the entire surface of the substrate. In that case, it would simply be necessary to apply transparent modification ink to the entire surface, partially gelling/drying it, and subsequently applying the desired microparticles and performing complete curing/drying, without previously printing a specific digital image. These same steps can be performed by generating a dispersion of microparticles in an ink, varnish or lacquer and applying it to the entire surface by means other than digital printing (since it would not enable application due to the size of the microparticles) such as by roller, curtain, etc. These means make it possible to apply said dispersion with more permissiveness in terms of the size of the microparticles, but with the drawback of not being able to precisely select the areas of application.

In another exemplary embodiment of the invention, the procedure may comprise performing a texturing. This texturing is performed by removal means, which may comprise, for example, brushing on a layer to be textured, whereon an ink for texturing is applied and, subsequently, gelling/semi-drying of said layer and said ink is performed, texturing is performed and finally complete drying/curing of the textured layer is performed. These steps are preferably performed before applying the microparticles.

In another possible embodiment, the steps corresponding to the texturing of a layer to be textured are repeated to create additional textured areas. In these cases, the steps relating to the modification of properties by applying microparticles can also be repeated again.

Another object of the invention is a machine for digital decoration of a substrate according to the previously described procedure. Said machine comprises at least injection heads for injecting the ink, curing and/or drying means, dosing heads for dosing the microparticles and vacuuming the excess ones, mechanical cleaning means (optionally) and a control unit configured for synchronising/coordinating the decorative motif and the property modification pattern and, depending on said synchronisation, controlling the rest of the elements.

In cases where texturing is also to be performed, the machine also comprises at least one texturing means, which can be, for example, a brush.

In short, the decorative motif is printed with inks that may or may not be pigmented and at least one of said inks (modification ink) will be gelled/semi-dried such that it acts as an adhesive for the microparticles that are subsequently applied to the decorative motif. As said microparticles are small in size (although large enough so that they cannot be injected with standard ink injection heads), it is very convenient to sprinkle them over the entire surface, although they are trapped only in the areas where the modification ink is gelled/semi-dry. Thus, the procedure comprises subsequent vacuuming of the excess microparticles.

Therefore, in a first aspect of the invention, a procedure for digital decoration of substrates comprising a surface is proposed. Said procedure of digital decoration of a substrate comprises steps of:
a) injecting a modification ink by means of digital application, at predetermined points on the surface of the substrate corresponding to specific points that make up a property modification pattern;
b) gelling or performing a first drying of said modification ink, so that it acquires a predetermined degree of gelling or drying;
c) dosing microparticles, with certain physical properties, on the substrate with the modification ink such that a portion of said microparticles remains adhered to the gelled/semi-dry modification ink, modifying the physical properties of the modification ink at said points that make up the modification pattern;
d) after applying the microparticles, vacuuming the microparticles that have not remained adhered to the modification ink;
e) performing partial or complete curing or drying of the modification ink with the microparticles.

Preferably the microparticles that are dosed have a maximum size of 20 μm.

In a more detailed example, the surface is already suitable or is previously prepared to receive at least one liquid ink on which a decorative motif is to be printed and the procedure comprises the following steps:
printing a decorative motif by means of the injection of decorative ink, pigmented or not, onto the substrate, and
after each injection of decorative ink, drying/curing said injected decorative ink;
performing steps a) to e).

The step of drying/curing said injected decorative ink after each injection of decorative ink may comprise complete drying/curing of each previously injected ink or partial drying/curing, in which case the procedure includes, before performing steps a)-e), an intermediate step of performing complete drying/curing of the inks injected on the surface of the substrate.

In another exemplary embodiment, the step of gelling or semi-drying the modification ink is partial, and a total curing or drying of the rest of said modification ink is performed, such that the microparticles that are subsequently dosed remain attached only to the gelled or semi-dry areas of the modification ink.

Likewise, steps a)-e) are repeated as many times as necessary depending on the modification pattern and the number of different modification inks and/or physical properties to be varied for each one of the modification inks.

In one embodiment of the invention, after step e), a step of mechanically cleaning by contacting the microparticles that may have remained loose after the drying or curing of said step e) is performed.

In other exemplary embodiments, as previously described, the procedure may comprise steps prior to steps a)-e), comprising:
applying a layer to be textured;
optionally partially drying or curing said layer to be textured;
applying an ink for texturing;
gelling/semi-drying said layer and ink for texturing;
brushing to get the texture;
fully drying or curing said already textured layer.

Likewise, the procedure may additionally comprise steps of:
f) applying a finishing layer or finishing varnish on the surface of the substrate;
g) drying or curing said finishing layer or finishing varnish.

The application of a finishing layer or varnish makes it possible, for example, to give the substrate greater resistance to wear, a certain aesthetic appearance such as matt or gloss, etc.

As previously seen, in a preferred embodiment, the microparticles that are dosed are sublimable.

Likewise, in a preferred example, a longitudinal control of the movement of the substrate, of the decorative ink injection, of the modification ink injection and of the sprinkling of the microparticles is continuously performed such that the synchronisation between the printed digital motif to be printed and modification pattern is ensured.

In a second aspect of the invention, a machine for digital decoration of a substrate according to the previously described procedure is proposed. The machine comprises transport means for moving the substrate, injection heads for ink injection, curing and/or drying means, a dosing station comprising dosing heads and at least one vacuuming head for the subsequent vacuuming of the non-adhered microparticles and a control unit configured for synchronising the application of the decorative motif and the property modification pattern and, based on said synchronisation, controlling the movement of the transport means and the rest of the elements.

Preferably, the machine also comprises application means for applying one or more substrate preparations (such as, for example, different application means for applying layers of liquid materials) and first drying/curing means. It may also comprise application means for applying the finishing layer configured for applying a finishing layer to the substrate and final drying/curing means configured for curing/drying said previously applied finishing layer. Also preferably, each curing and/or drying element is arranged after an ink injection head configured for curing/gelling and/or semi-drying/drying at least the type of ink injected by the previous ink injection head.

Preferably, the machine also comprises application means for applying a layer to be textured and application means for applying an ink to be textured. It also comprises texturing means that can be, for example, a brush.

Throughout this specification, the term substrate is generally used for discrete substrates (such as boards, panels, sheet metal or unitary pieces in general, particularly chipboards, wood fibre boards (MDF, HDF), cement fibre boards or similar, plastic panels or sheets, for example made of PVC, as well as sheets or panels made of composite materials, currently widely used in the flooring manufacturing industry, such as LVT (Luxury Vinyl Tile), SPC (Stone Plastic Composite), WPC (Wood Plastic Composite), metal panels or sheets, for example made of aluminium, steel, etc., cork panels or sheets, etc.

The term substrate also includes continuous materials to be applied, for example, supplied in rolls or strips, such as a roll, coil or strip of thin wood veneer, a roll or coil of steel, paper, plastic, cork, etc. As a particular case for applying a material with these features according to the invention, said roll material is uncoiled to apply the procedure thereon and, preferably, a subsequent collection by means of rewinding is performed.

### BRIEF DESCRIPTION OF THE FIGURES

To complete the description, and for the purpose of helping to make the features of the invention more readily understandable, this description is accompanied by a set of drawings constituting an integral part of the same, which by way of illustration and not limitation represents the following:

FIGS. 1A-B represent a view of an exemplary embodiment of the procedure of the invention using different types of primers and decorative inks together with the corresponding drying/curing means depending on said primers/decorative inks.

FIGS. 2A-B represent a view of another exemplary embodiment of the procedure of the invention using different types of primers and decorative inks together with the corresponding drying/curing means depending on said primers/decorative inks.

FIG. 3 shows another possible exemplary embodiment wherein a transparent ink (or ink different from those used for decoration) is used.

FIGS. 4A-B show a view of another exemplary embodiment of the procedure of the invention wherein at least one texturing is performed.

### DETAILED DESCRIPTION

The present invention should not be limited to the embodiment described herein. Other configurations may be carried out by those skilled in the art based on the present description. Accordingly, the scope of the invention is defined by the following claims.

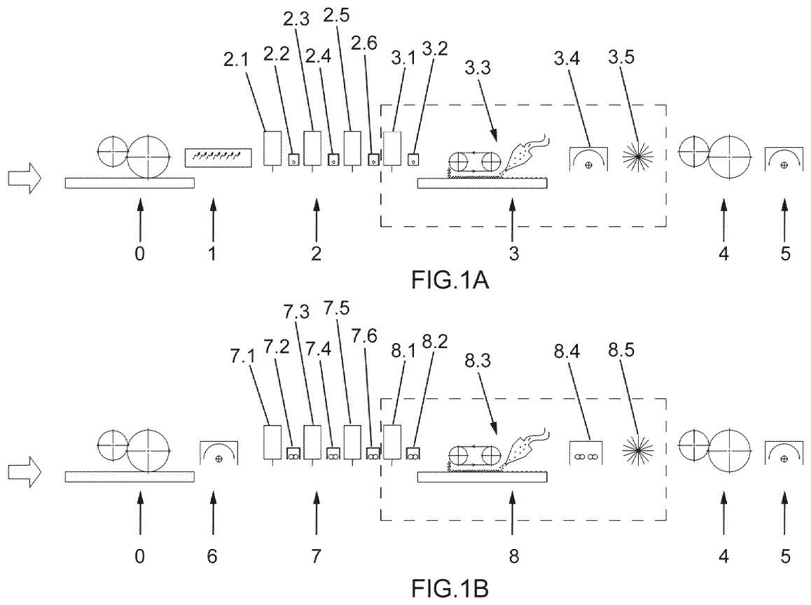

FIGS. 1A-B represent a procedure for digital decoration of a substrate wherein inks of different types have been used. After applying each one of them, the corresponding UV or IR curing/drying is performed. In both FIGS. 1A-B, a preliminary step of applying a preparation layer (0) or primer is performed. In FIG. 1A, said primer is solvent-based, water-based, etc. and to perform the previous drying, drying by evaporation (1) is used. In the case of FIG. 1B, a primer is used that can be, for example, of the polymerisable type, for the fixation of which previous curing (6) is performed.

Subsequently, in both cases, the steps of applying different inks (2.1, 2.3, 2.5, 7.1, 7.3, 7.5) and drying/curing each one of said inks after the application thereof (2.2, 2.4, 2.6, 7.2, 7.4, 7.6) are performed. The example of FIG. 1A shows that the curing is performed using UV lamps (2.2, 2.4, 2.6). The example of FIG. 1B shows that the drying is performed using IR lamps (7.2, 7.4, 7.6).

After these steps, step a) is performed by injecting a modification ink that may or may not be pigmented, by means of digital application with an injection head (3.1, 8.1), at predetermined points on the surface of the substrate corresponding to specific points of the decorative motif that make up a property modification pattern. After this modification ink injection, step b) is performed, which includes gelling (3.2) (for example by applying UV radiation as in FIG. 1A) or first drying (8.2) (semi-drying) (for example by evaporation due to the application of IR (infrared) radiation as in FIG. 1B).

In step c) of the procedure, a dosing of the microparticles that are going to be used to modify the properties of the decorative motif is performed. Said microparticles are applied over the entire surface of the substrate as it advances under the corresponding heads. Due to their size they are applied as a “particle curtain” that falls on the surface of the substrate, along the entire width thereof. A greater or smaller number per unit area (grammage) can be applied and whether the entire substrate or only some areas thereof are to be applied can be controlled. When it is said they can only be applied in some areas, this involves areas of a relatively large size since, due to the small size of the microparticles, performing the application only on specific points is very complex and not feasible.

FIGS. 1A-B show how the application of microparticles (3.3, 8.3) is performed in both cases and how step d) is performed, i.e., a vacuuming of the excess microparticles that have not adhered to the modification ink (they only adhere in the areas wherein the modification ink is gelled or semi-dry).

As a portion of the microparticles remains adhered to the gelled/semi-dry modification ink, it modifies the physical properties of the modification ink at said points that make up the property modification pattern and that is synchronised with the printed digital motif.

Subsequently, the curing/drying of the modification ink is completed (step g)), with the microparticles already adhered thereto (3.4, 8.4). Again, the type of fixation will depend on the type of modification ink applied. In these examples, curing using UV (ultraviolet) electromagnetic radiation (3.4) and another drying using IR (infrared) electromagnetic radiation (8.4) are observed. FIGS. 1A-B also represent a mechanical cleaning (step e)), after fixation, which ensures the correct removal of all the excess microparticles, in the event that some remained after the first vacuuming.

As we can see in these figures, different fixing mechanisms are preferably selected for the primer and for the inks, so as to avoid interference between the fixations used in each case. These fixing mechanisms could also be identical in one same process if the primers, inks and/or said fixing devices are properly designed for it.

Steps a)-e) can be encompassed as steps to be performed in each property modification cycle (3, 8). When various types of modification inks are to be applied, repeating these steps to achieve the modification of the properties of the decorative motif is required.

As can be seen in the figures, the steps of applying a finishing layer or finishing varnish (4) and final curing/drying (5) can subsequently be performed to fix said top layer or varnish.

In addition, the gelling or semi-drying (3.2, 8.2) of the modification inks can be applied to the entire modification ink (3.1, 8.1) or be selectively performed. In this second case, some of the areas of the modification ink are completely cured/dried and gelling/semi-drying are applied to the rest of them. In this way, when the microparticles are applied, they only stick to a portion of the modification ink applied.

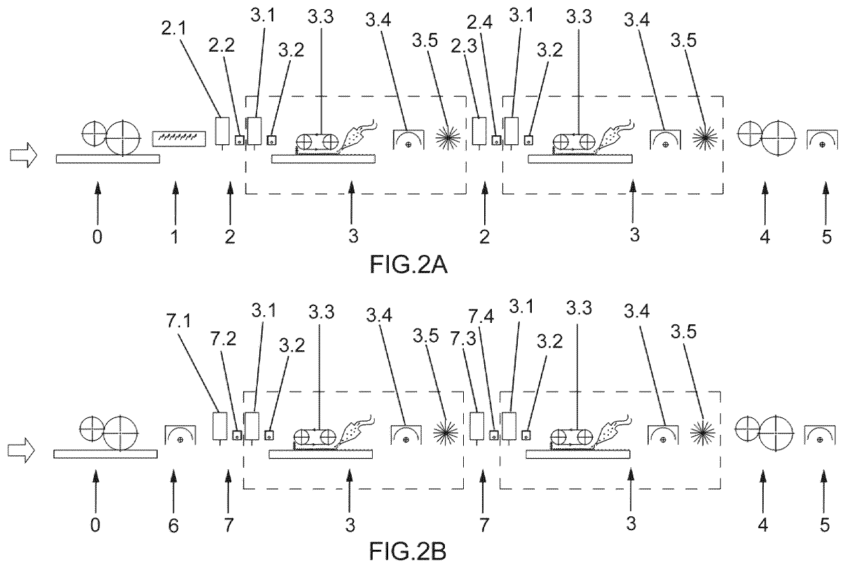

FIGS. 2A-B show an exemplary embodiment of the procedure wherein, for example, different types of microparticles are to be applied on one same modification ink (for example, a pigmented ink so that different properties are achieved on the same colour). In this case, the modification cycles (3, 8) are repeated, repeating the application of the same type of modification ink and performing a subsequent application of microparticles with different properties.

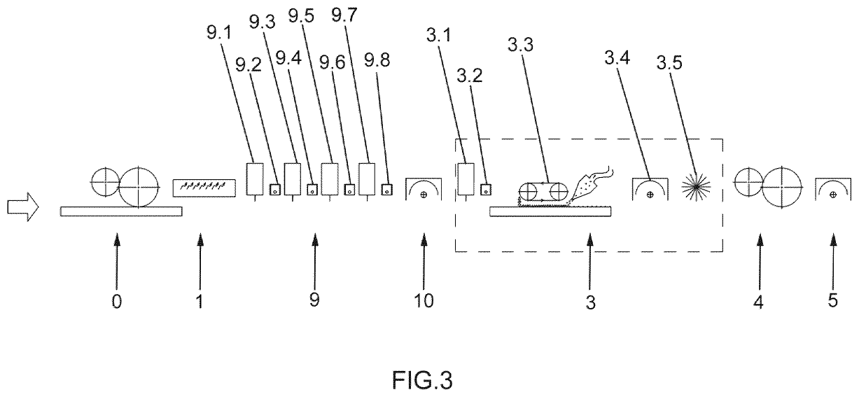

FIG. 3 shows another exemplary embodiment. In this case, a procedure like the one of the invention is shown wherein a preparation layer (0) is applied, which in this case is a primer, a first drying or curing (1) of said preparation layer is performed, in this case by evaporation, and subsequently a colour decoration is applied by means of digital printer (9.1, 9.3, 9.5, 9.7), curing/drying each ink after the application thereof (9.2, 9.4, 9.6, 9.8). This curing/drying can be total or partial since, as shown in the figure, after the step of applying and curing/drying the inks (9), a total curing/drying (10) is subsequently performed. In another exemplary embodiment, instead of a preparation layer (0), a layer to be textured (0) is applied.

Next, the application of the modification ink (3.1), the corresponding gelling (3.2) thereof and the application of the microparticles (3.3) are performed with the vacuuming of those which are not adhered to the modification ink. In this exemplary embodiment, the microparticles can provide a metallic optical effect on the selected areas (on which the modification ink has been applied). The steps of fully curing (3.4) the modification ink are also performed and any possible remaining microparticles are removed by mechanical procedures (3.5).

Finally, the protective layer (4) (or finishing varnish) is provided and curing (5) is performed, which in this case is complete UV curing of the image obtained (image printed with the ink and with the modification ink) with the protective layer.

In this exemplary embodiment (FIG. 3), intermediate curing (9.2, 9.4, 9.6, 9.8) is partial curing, thus obtaining a gelling condition therein. Full fixation between colours (different inks applied (9.1, 9.3, 9.5, 9.7)) is not required since they are fixed at the end, before applying the modification ink and the microparticles. In this case, the modification ink can be a transparent ink, which is applied, for example, on some areas of the previously applied colours, such that, when the microparticles are applied, they remain attached to the transparent ink layer, modifying the properties of the design in the portions where the microparticles have been fixed.

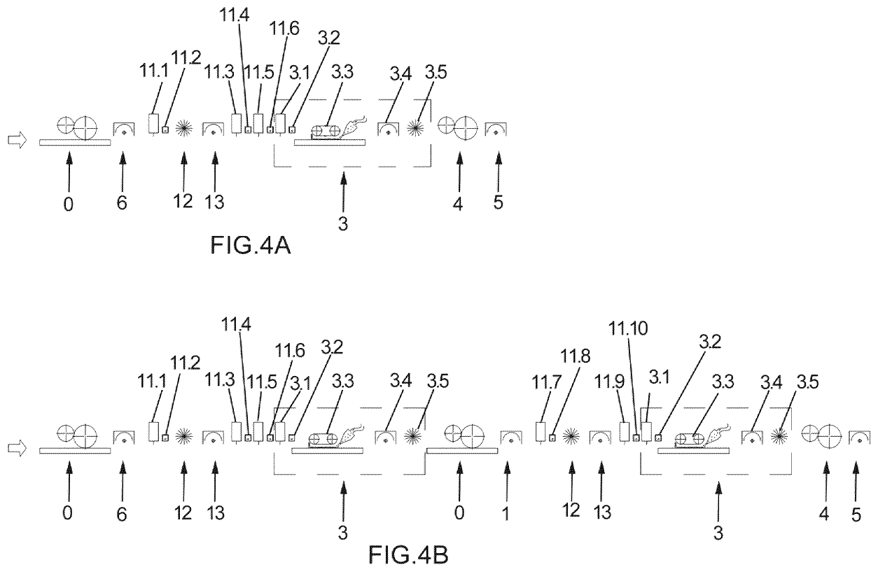

FIG. 4A shows another possible embodiment of the invention wherein texturing is performed. As can be seen in the figure, the procedure comprises performing a previous step of applying a layer to be textured (0) and, optionally, previous drying/curing (6) is performed. Subsequently, an ink for texturing (11.1) is applied, curing (11.2) is applied, it is textured with removal means (12) to obtain a certain texture and total drying/curing (13) of said already textured layer is performed. Once the desired areas of the surface of the substrate have been textured, inks (11.3, 11.5) that are partially gelled/cured (11.4, 11.6) are applied and the substrate goes through a modification cycle (3) in which it is printed with the ink to be modified and the microparticles are applied on said ink to be modified. The final steps are those already described for the procedure of the invention, i.e., a finishing layer or finishing varnish (4) is applied and final curing/drying is performed to fix said top layer or varnish (5).

In another exemplary embodiment, shown in FIG. 4B, after the modification cycle (3) another layer to be textured (0) can be applied and all the previously described steps can be repeated again. At the end of the procedure, as in the previous case, a finishing layer or finishing varnish (4) and final curing/drying (5) are applied. Said FIG. 4B shows an example where a layer to be textured (0) is applied, optionally first drying (6) is performed and an ink for texturing (11.1) is injected and both the layer and the ink are gelled/semi-dried (11.2) and subsequently texturing by means of a brush (12) and curing of said already textured layer (13) is performed. Subsequently, different inks (11.3, 11.5) are applied and the corresponding drying (11.4, 11.6) is performed. After performing these steps, steps a)-e) of the procedure are performed, in the modification cycle (3). In this example, an application of an additional layer to be textured (0) is subsequently performed and all the steps are repeated again such that said additional layer to be textured (0) is optionally cured with a first curing (6), another ink for texturing (11.7) is applied and corresponding gelling/semi-drying (11.8), subsequent texturing (12) to provide it with texture, and total curing (13) is applied. After these steps, additional inks (11.9) can be applied which are correspondingly cured (11.10) and steps a)-e) are performed in another modification cycle (3). Finally, a protective layer or protective varnish (4) and final total drying (5) can be applied.

Likewise, in FIGS. 1A-B, 2A-B, 3 and 4A-B, different exemplary embodiments of a machine for digital decoration of a substrate can be seen, which is also the object of the invention. As can be seen in the figures, in all embodiments there are common elements and subsequently, elements are modified or added or redistributed depending on the type of ink used. For example, if water-based inks are used, drying means are used that include drying by evaporation; if polymerisable inks are injected, means for curing or polymerisation are used, such as electromagnetic radiation, and in particular UV, etc.

Some of the elements of the machine for digital decoration of a substrate of the present invention are transport means for moving the substrate, injection heads for ink injection (2.1, 2.3, 2.5, 3.1, 7.1, 7.3, 7.5, 9.1, 9.3, 9.5, 9.7, 8.1, 11.1, 11.3, 11.5, 11.7, 11.9), curing and/or drying means (2.2, 2.4, 2.6, 3.2, 3.4, 7.2, 7.4, 7.6, 8.2, 8.4, 9.2, 9.4, 9.6, 9.8, 10, 11.2, 13, 11.4, 11.6, 11.8, 11.10), a dosing station (3.3, 8.3) comprising dosing heads and at least one vacuuming head for applying the microparticles by dosing and subsequent vacuuming of non-adhered ones. Likewise, the machine comprises a control unit configured for synchronising the decorative motif and the property modification pattern and, based on said synchronisation, controlling the movement of the transport means and the rest of the elements.

Preferably, as can be seen in the figures, the machine additionally comprises application means for applying a primer or preparing the substrate (0) and first drying/curing means (1,6).

The machine may additionally comprise application means for applying finishing or top layers (4) configured for applying a finishing layer, for example a protective layer, on the substrate, and final drying/curing means (5) configured for curing/drying said previously applied finishing layer.

In addition, as described, in an exemplary embodiment, each curing and/or drying means (2.2, 2.4, 2.6, 3.2, 7.2, 7.4, 7.6, 8.2, 9.2, 9.4, 9.6, 9.8, 11.2, 11.4, 11.6, 11.8, 11.10, 13) is arranged after an ink injection head (2.1, 2.3, 2.5, 3.1, 7.1, 7.3, 7.5, 8.1, 9.1, 9.3, 9.5, 9.7, 11.1, 11.3, 11.5, 11.7, 11.7, 11.9) configured for curing/drying the type of ink injected by the previous ink injection head (2.1, 2.3, 2.5, 3.1, 7.1, 7.3, 7.5, 8.1, 9.1, 9.3, 9.5, 9.7, 11.1, 11.3, 11.5, 11.7, 11.9). Also preferably, the machine comprises at least one removal means, which may comprise at least one brush (12) for applying texturing to a layer to be textured (0).

1. A procedure for digital decoration of a surface of a substrate wherein the procedure comprises steps of:
a) injecting a modification ink by means of digital application, at predetermined points on the surface of the substrate corresponding to specific points that make up a property modification pattern;
b) gelling or performing a first drying of said modification ink, so that it acquires a predetermined degree of gelling or drying;
c) dosing microparticles, with certain physical properties, on the substrate with the modification ink such that a portion of said microparticles remains adhered to the gelled/semi-dry modification ink, modifying the physical properties of the modification ink at said points that make up the modification pattern;
d) after applying the microparticles, vacuuming the microparticles that have not remained adhered to the modification ink;
e) performing partial or complete curing or drying of the modification ink with the microparticles.

2. The procedure according to claim 1, wherein the substrate comprises a decorative motif and the modification pattern is synchronised with said already printed decorative motif.

3. The procedure according to claim 1, comprising the following steps, prior to performing step a):
printing a decorative motif by means of the injection of decorative ink onto the substrate;
after each injection of decorative ink, curing/drying said injected decorative ink.

4. The procedure according to claim 1, further comprising at least one step of printing a decorative motif on the surface of the substrate, wherein said decorative motif is synchronised with the modification pattern.

5. The procedure according to claim 1, wherein the maximum average size of the microparticles is 20 μm.

6. The procedure according to claim 3, wherein the step of curing/drying the injected decorative ink may comprise complete curing/drying of each previously injected ink or partial curing/drying, in which case the procedure includes an additional step of performing complete curing/drying of the inks that are injected onto the surface of the substrate.

7. The procedure according to claim 1, wherein in step b) partial gelling or semi-drying of the modification ink is performed and total curing or drying of the rest of said modification ink is performed such that the microparticles that are applied in step c) are attached only to the gelled or semi-dry areas of the modification ink.

8. The procedure according to claim 1, wherein steps a) to e) are repeated as many times as necessary depending on the modification pattern and the number of different modification inks and/or physical properties to be varied for each one of the modification inks.

9. The procedure according to claim 1, wherein after step e) a step of mechanically cleaning by contacting the microparticles that may have remained loose after the drying or curing of step e) is performed.

10. The procedure according to claim 1, further comprising steps of:
f) applying a finishing or top layer or finishing or top varnish on the surface of the substrate;
g) drying or curing said finishing layer or finishing varnish.

11. The procedure according to claim 1, wherein the microparticles that are dosed are sublimable.

12. The procedure according to claim 1, wherein a longitudinal control of the movement of the substrate, of the modification ink injection and of the dosing of the microparticles is continuously performed such that the synchronisation between the printed digital motif and the modification pattern is ensured.

13. The procedure according to claim 12, wherein a control of the decorative ink injection on the substrate is additionally performed.

14. The procedure according to claim 1, wherein the initial treatment of the substrate comprises applying a preparation layer and/or a layer to be textured.

15. The procedure according to claim 14, comprising performing first drying or curing of said preparation layer and/or layer to be textured.

16. The procedure according to claim 14, wherein, after applying a layer to be textured, an ink for texturing is printed and gelling/semi-drying is performed on the layer to be textured and the ink for texturing, and texturing by removal and total drying/curing is performed, before performing steps a)-e).

17. The procedure according to claim 16, wherein, after performing steps a)-e), another layer to be textured is applied and another ink for texturing is printed and partial gelling/semi-drying is performed on said another layer to be textured and said another ink for texturing, texturing is performed, total drying/curing is performed.

18. A machine for digital decoration of a substrate according to the procedure described in claim 1, comprising transport means for moving the substrate, injection heads for ink injection, curing and/or drying means, an application station comprising dosing heads and at least one vacuuming head for dosing the microparticles and subsequent vacuuming of the non-adhering ones and a control unit configured for synchronising the decorative motif and the property modification pattern and, based on said synchronisation, controlling the movement of the transport means and the rest of the elements.

19. The machine according to claim 18, further comprising application means for applying a preparation layer and first drying/curing means.

20. The machine according to claim 18, further comprising application means for applying a finishing layer configured for applying a finishing layer on the substrate and final drying/curing means configured for curing/drying said previously applied finishing layer.

21. The machine according to claim 18, wherein each curing and/or drying means is arranged after an ink injection head and is configured for curing/drying the type of ink injected by the previous ink injection head.

22. The machine according to claim 18, further comprising removal means configured for applying a texturing on a layer to be textured.

23. The machine according to claim 22, wherein the removal means comprise at least one brush.
